(19) United States
(12) Patent Application Publication
(10) Pub. No.: US 2004/0255718 A1
(43) Pub. Date: Dec. 23, 2004

(54) Turbine powered flywheel

(76) Inventor: Jerome Andrew Steers, Miami, FL (US)

Correspondence Address: JEROME STEERS, 7900 SW 118TH STREET, MIAMI, FL, 33156, US

(21) Appl. No.: 10/464,093

(22) Filed: Jun. 18, 2003

(51) Int. Cl. G05G 1/00

(52) U.S. Cl. 74/572

(57) ABSTRACT

A spherical mass with the general dimensions of a disc supported at its central axis by a bearing to facilitate rotation, and connected to a turbine driven shaft to enable its rotation, and with a power take off shaft through which the stored energy would be delivered as needed. The accelerating exhaust gases would impinge upon the blades of the said turbine driven shaft thus causing it to rotate rapidly and enable the rotation of the flywheel due to its being in contact with the flywheel through the enmeshing of gear teeth on the turbine driven shaft with gear teeth on the flywheel.

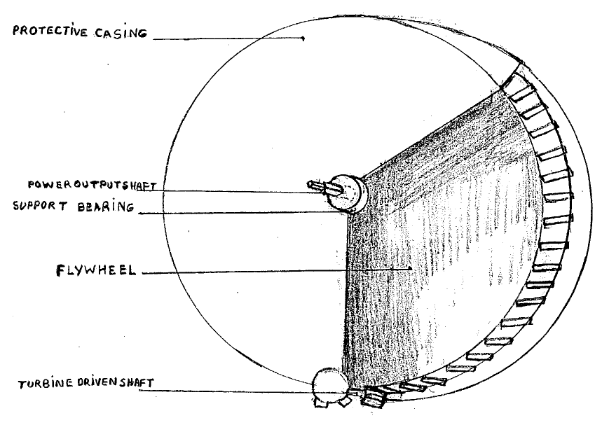

The method described results in a turbine driven flywheel that captures and stores useful amounts of reusable energy that would normally be wasted by internal combustion engines.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO MICROFICHE APPENDIX

Not Applicable

### BACKGROUND OF THE INVENTION

This invention relates to energy recovery/storage devices, specifically to flywheels. Flywheels store energy and make it available for use as needed.

There is a need for a simple, inexpensive and easily applied energy recovery/storage device. This energy recovery/storage device could have applications in internal combustion engines. It could save energy and reduce air pollution

No present devices handily fit the bill. Current energy recovery devices are extremely costly, cumbersome and are not easily adapted to needed uses.

### BRIEF SUMMARY OF THE INVENTION

The present invention has utility in saving energy by improving fuel economy. It would also reduce air pollution caused by internal combustion engines. It could bring a new level of reliability and economy to these engines. The Turbine Powered Flywheel, would be very economical to manufacture and acquire. It could be easily applied to engines being presently produced.

Internal combustion engines currently waste more than 60% of the energy from fuel utilized. A substantial amount therefore, stands to be recovered. Some of the wasted heat and kinetic energy in the exhaust of these engines would be captured by a turbine affixed to a shaft which would be used to rapidly rotate a suitably sized flywheel in a protective casing, up to high speed, thereby continuously storing significant energy which could be returned by way of a power output shaft, to the engine or drive train of a mobile vehicle or stationary power producing internal combustion engine.

This returned energy could be used to assist stationary power producing internal combustion engine in periods of peak load, as well an existing internal combustion engine mounted in a mobile vehicle such as an automobile, in moving said vehicle from rest with less effort, thereby reducing engine wear and increasing fuel economy because, the engine would not have to work as hard, or use the same amount of fuel normally used to perform such a task. Additionally, by using a smaller engine matched with a turbine powered flywheel to power an automobile of a given specification, greater fuel economy and less engine wear, would also be achieved. By using less fuel, air pollution would be reduced also. Since the energy would be continuously stored, meaning that the flywheel would be kept continuously recharged, it could also add power to a vehicle already underway when needed in certain situations such as negotiating a steep hill.

### BRIEF DESCRIPTION OF THE DRAWING

The drawing depicts the fully assembled invention as described.

### REFERENCE NUMERALS IN DRAWING

2. A Flywheel.

4. Protective Casing.

6. Support Bearing.

8. Turbine Driven Shaft

10. Power Output Shaft

### DETAILED DESCRIPTION OF THE DRAWING

(2) A Flywheel made of a spherical mass of suitably durable material with the general dimensions of a disc, (4) housed in a protective casing and supported at its central axis by (6) a bearing to facilitate rotation, and connected to (8) a turbine driven shaft to enable its rotation, and connected to (10) a power output shaft through which the stored energy would be delivered as needed. The accelerating exhaust gases would impinge upon the turbine blades affixed to the said turbine driven shaft thus causing it to rotate rapidly and enable the rotation of the flywheel due to its being in contact with the flywheel through the enmeshing of gear teeth on the turbine driven shaft with gear teeth on the flywheel.

Although the description above contains many specificities, these should not be construed as limiting the scope of the invention but as merely providing illustrations of some of the presently preferred embodiments of this invention. For example, the turbine arrangement and or flywheel shape or dimensions could be changed, the flywheel could be constructed of various materials.

Thus the scope of the invention should be determined by the appended claims and their legal equivalents, rather than by the examples given.

Ease of use, increased fuel economy, less air pollution, less engine wear would be realized.

The abovementioned attributes would lead to widespread use and thereby save energy and lower air pollution.

I claim:

1. A turbine driven flywheel, comprising:
1. A spherical mass circular in shape made of a suitably durable material with the general dimensions of a disc supported at its central axis by a bearing to facilitate rotation, and connected to a turbine driven shaft to enable its rotation, and an output shaft through which the stored energy would be delivered as needed.
2. A turbine driven shaft to enable the rotation of the flywheel due to its being in contact with the flywheel through the enmeshing of gear teeth on the turbine driven shaft with gear teeth on the flywheel.
Whereby it would be possible to economically construct a rugged, simple, reliable, easily adapted, energy recovery device to enable increased fuel economy, less air pollution, and less engine wear.
